(19) United States
(12) Patent Application Publication
(10) Pub. No.: US 2025/0292585 A1
(43) Pub. Date: Sep. 18, 2025

(54) VIDEO RECORDING SYSTEM, IMAGE ACCESS METHOD, AND NON-TRANSITORY COMPUTER READABLE MEDIUM

(71) Applicant: AmTRAN Technology Co., Ltd., New Taipei City (TW)

(72) Inventor: Kuo Chih LO, New Taipei City (TW)

(21) Appl. No.: 19/059,274

(22) Filed: Feb. 21, 2025

(30) Foreign Application Priority Data
Mar. 15, 2024 (TW) 113109823

(51) Int. Cl. G06V 20/54; G06V 10/25; G06V 10/82; G06V 20/40; G06V 20/70

(52) U.S. Cl. CPC G06V 20/54; G06V 10/25; G06V 10/82; G06V 20/44; G06V 20/70; G06V 2201/07

(57) ABSTRACT

A video recording system includes a camera, a memory device, and a processor. The memory device is for storing at least one script code. The processor is electrically connected to the camera and the memory device, and for performing at least following steps when reading the at least one script code: capturing a plurality of images through the camera to generate a video; identifying at least one generic object in a plurality of frames in the video; determining an image scene according to the at least one generic object; performing a specific object detection according to the image scene to determine whether at least one specific object or at least one specific event appears in the frames; and attaching a label to at least one of the frames with the at least one specific object or the at least one specific event.

### RELATED APPLICATIONS

This application claims priority to Taiwan Application Serial Number 113109823, filed Mar. 15, 2024, which is herein incorporated by reference.

### BACKGROUND

### Technical Field

The present disclosure relates to a video recording system, image access method and non-transitory computer readable medium, especially relates to a video recording system, image access method and non-transitory computer readable medium applied to record a video for performing an object detection.

### Description of Related Art

Modern people's lives are always filled with various image recording devices, such as cameras, driving recorders, monitors or body cameras, etc. However, the biggest problem with these products is that starting and stopping photography requires manual control by users. Even the videos taken subsequently require users to spend a lot of time sorting them out, and using advanced image processing software to review the video clip by clip slowly to find meaningful clips for editing. Often this situation will cause users to lose interest and stop using the product, or save the recorded image to the hard disk for future use, but give up because it cannot store too much data.

Therefore, how to provide a video recording system to solve the above problems is a critical issue in this field.

### SUMMARY

One embodiment of the present disclosure directs to a video recording system. The video recording system includes a camera module, a memory device, and a processing unit. The memory device stores at least one script code. The processing unit is electrically connected to the camera and the memory device. When the processing unit reads the at least one script code, the processing unit performs at least the following steps. A plurality of images is captured through the camera module to generate a video. At least one generic object in a plurality of frames in the video is identified. An image scene according to the at least one generic object is determined. According to the image scene, a specific object detection is performed to determine whether at least one specific object or at least one specific event appears in the frames. A label is attached to at least one of the frames with the at least one specific object or the at least one specific event.

Another aspect of the present disclosure directs to an image access method. The image access method includes the following steps. A generic object detection is performed on a plurality of frames of a video to identify at least one generic object in the frames. According to the at least one generic object, an image scene is determined. According to the image scene, a specific object detection is performed on the frames to determine whether at least one specific object or at least one specific event is in the frames. When the at least one specific object or the at least one specific event is detected in the frames, at least one label is attached to the frame where the at least one specific object or the at least one specific event appears. The frames with the at least one label are stored.

Another aspect of the present disclosure directs to a non-transitory computer readable medium. The non-transitory computer readable medium stores at least one script code, and when the at least one script code is read, at least the following steps are performed. A generic object detection is performed on a plurality of frames of a video to identify at least one generic object in the frames. According to the at least one generic object, an image scene is determined. According to the image scene, a specific object detection is performed on the frames to determine whether at least one specific object or at least one specific event appears in the frames. When the at least one specific object or the at least one specific event is detected in the frames, at least one label is attached to the frames where the at least one specific object or the at least one specific event appears. The frames with the at least one label are stored.

In summary, the video recording system of the present disclosure is able to automatically analyze the specific objects or specific events in the video, and attach labels to the video frames. In this way, users may filter image clips covering the specific objects in the specific image scenes according to the labels, thereby reducing the difficulty for users to find the specific objects/events in a large number of accumulated recorded videos, while also increasing the value of recorded videos, and simplifying the video editing process.

### BRIEF DESCRIPTION OF THE DRAWINGS

The foregoing aspects and many of the accompanying advantages of this disclosure will become more readily appreciated as the same becomes better understood by reference to the following detailed description, when taken in conjunction with the accompanying drawings.

FIG. 1A is a schematic diagram of a video recording system in accordance with some embodiments of the present disclosure.

FIG. 1B is a schematic diagram of a video recording system in accordance with some embodiments of the present disclosure.

FIG. 2 is a schematic flowchart of an image access method of the video recording system in accordance with some embodiments of the present disclosure.

FIGS. 3A and 3B are schematic flowcharts of some steps of the image access method in accordance with some embodiments of the present disclosure.

FIG. 4A to FIG. 4C are schematic diagrams of a road scene in accordance with some embodiments of the present disclosure.

FIG. 5A to FIG. 5C are schematic diagrams of a shopping scene in accordance with some embodiments of the present disclosure.

FIG. 6A and FIG. 6B are schematic diagrams of a landscape scene in accordance with some embodiments of the present disclosure.

### DETAILED DESCRIPTION

The following embodiments are described with reference to the accompanying drawings, but such embodiments are not intended to limit the scope of the disclosure. The descriptions of operation of structure are not intended to limit the execution order. Any device produced with structure by recombining elements having equivalent effect, is intended to be within the scope of the disclosure. Additionally, the drawings are for illustrative purposes only and are not drawn according to original size. For better understood, the same or similar elements are identified with the same symbols in the following description.

Unless otherwise defined, terms used in this specification and claims are to be understood in their ordinary meaning as known in the art to which this disclosure pertains, the disclosure and the unique content. Furthermore, the terms “comprising,” “including,” “having,” “containing,” and the like are to be construed as open-ended terms (i.e., meaning “including, but not limited to”). Additionally, the term “and/or” means any one or more of the relevant listed items and all combinations thereof.

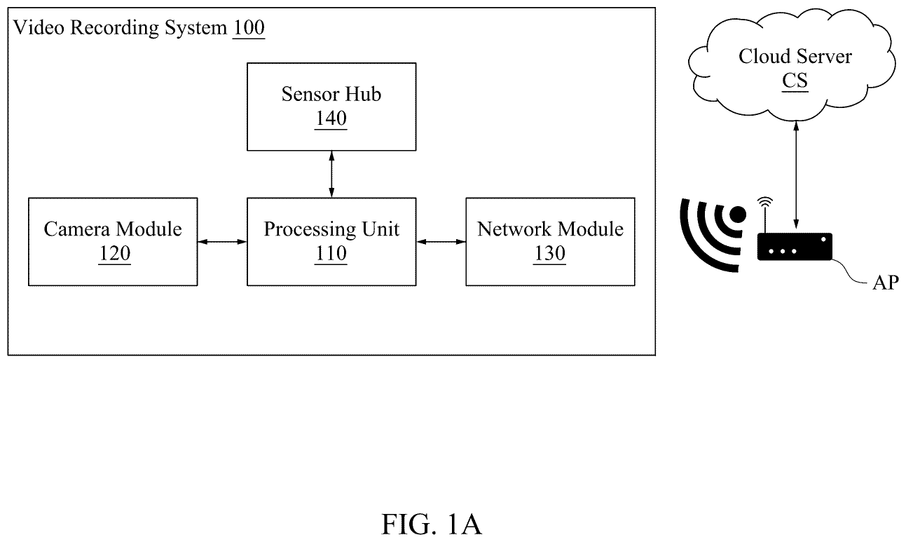

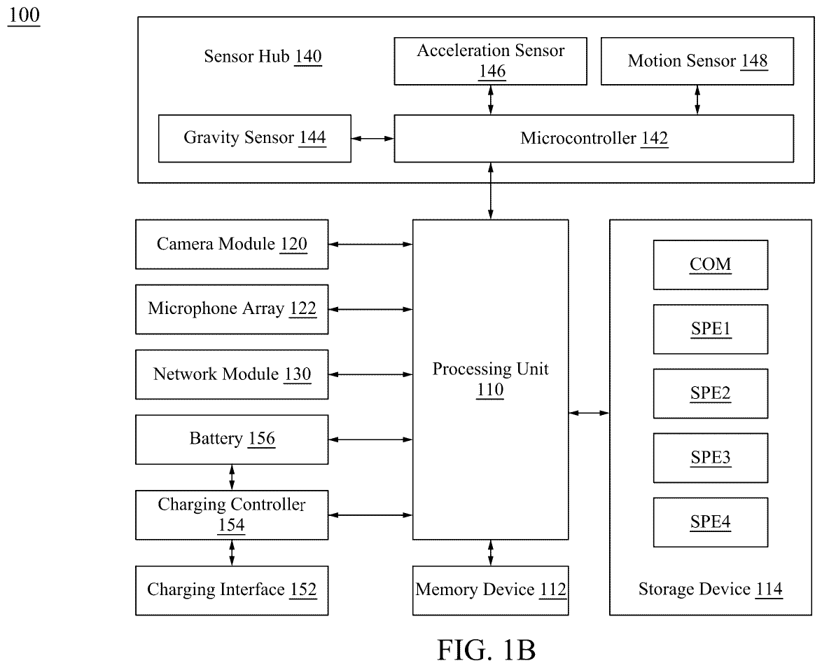

Please refer to FIG. 1A. FIG. 1A is a schematic diagram of a video recording system 100 in accordance with some embodiments of the present disclosure. As shown in FIG. 1A, the video recording system 100 includes a processing unit 110, camera module 120, network module 130, and sensor hub 140. In some embodiments, processing unit 110 may be an integrated circuit composed of a central processing unit (CPU) and a graphics processing unit (GPU). In some embodiments, the processing unit 110 may be regarded as a CPU and a GPU in a system on chip with a graphics processing unit. In some embodiments, processing unit 110 is electrically connected to the camera module 120, the sensor hub 140 and the network module 130. In some embodiments, camera module 120 may be implemented by a camera module. In some embodiments, the camera module 120 may be configured with the high frame rate camera (for example, a frame rate of 120 Hz), a high resolution (for example, a resolution of 4 million (1920×1080) or 12 million (4032×3040) pixels), and a wide viewing angle (for example, a 120-degree field of view). In some embodiments, the specifications of the camera of the camera module 120 may be selected based on the amount of temporarily recorded data, but it is not limited thereto. In some embodiments, the sensor hub 140 may receive, control, process, and integrate the sensing information from one or a plurality of sensors, and provide the processed sensing information to the processing unit 110. In some embodiments, the network module 130 provides mobile network connection function and GPS location information and is connected to the cloud server CS via the Internet. In some embodiments, the network module 130 includes a network control unit, a wireless communication interface, and/or a GPS receiver. In some embodiments, the network module 130 has a mobile network connection function and may provide GPS location information. In some embodiments, the network module 130 transmits data to the cloud server CS through a network. In some embodiments, the network control unit controls the wireless communication interface to connect to an access point AP, thereby connecting to the cloud server CS through the access point AP, and then transmits the video and image data to store on the cloud server CS through the network to allow users to view and manage data through mobile applications and computer programs.

Please refer to FIG. 1B. FIG. 1B is a schematic diagram of the video recording system 100 in accordance with some embodiments of the present disclosure. In some embodiments, the video recording system 100 further includes a memory device 112, a storage device 114, a microphone array 122, a battery 156, a charging controller 154, and a charging interface 152.

In some embodiments, the memory device 112 and/or the storage device 114 may be implemented by an electrical, magnetic, optical memory device or other storage device that stores instructions or data. In some embodiments, the memory device 112 and/or the storage device 114 may be implemented by volatile memory or non-volatile memory. In some embodiments, the memory device 112 and/or the storage device 114 may be implemented by a random access memory (RAM), a dynamic random access memory (DRAM), a magnetoresistive random access memory (MRAM), a phase change memory (PCM), or another storage device.

In some embodiments, the sensor hub 140 includes microcontroller 142. In addition, the sensor hub 140 may also include at least one sensor, such as an acceleration sensor 146, a motion sensor 148, and/or a gravity sensor 144. In this embodiment, the gravity sensor 144, the acceleration sensor 146 and the motion sensor 148 are electrically connected to the microcontroller 142. In some embodiments, the gravity sensor 144 and the acceleration sensor 146 are used for sensing the motion state of the video recording system 100 itself, and the motion sensor 148 is used for sensing the motion state of the surrounding environment. In some embodiments, the microcontroller 142 processes and transmits the sensing results of the gravity sensor 144, the acceleration sensor 146, and the motion sensor 148 to the processing unit 110, and the processing unit 110 controls the time to start recording and end recording of the camera module 120 according to the sensing results.

In some embodiments, the motion sensor 148 is electrically connected to the processing unit 110 through the microcontroller 142, and senses the motion state of people and objects in the surrounding environment to generate motion-sensing signals. In some embodiments, the motion sensor 148 may be implemented by an infrared sensor. In some embodiments, the motion sensor 148 is used to detect whether nearby people or objects are moving to generate the motion-sensing signals. That is, the motion-sensing signal includes the movement information of whether there are people or objects in the nearby environment of the video recording system 100. In some embodiments, if the processing unit 110 determines the movement of people or objects in the nearby environment of the video recording system 100 according to the motion-sensing signal generated by the motion sensor 148, the processing unit 110 controls the camera module 120 to be activated. In some embodiments, when the processing unit 110 receives the motion-sensing signal generated by the motion sensor 148, the processing unit 110 controls the camera module 120 to be activated to generate/record a video.

In some embodiments, the acceleration sensor 146 is electrically connected to the processing unit 110 through the microcontroller 142, and senses the acceleration information of the camera module 120. In some embodiments, when the camera module 120 performs the video recording, the processing unit 110 controls the acceleration sensor 146 to sense the acceleration information of the camera module 120. In some embodiments, according to the motion-sensing signal generated by the motion sensor 148 and the acceleration information generated by the acceleration sensor 146, the processing unit 110 may determine the motion state of the video recording system 100 itself (for example, the video recording system 100 is installed in a moving car thereby making the acceleration information to include changing acceleration value) and/or the motion state of people and objects in the nearby environment of the video recording system 100, so as to learn whether the usage status of the video recording system 100 is in an idle status. For example, assuming that the processing unit 110 determines that the video recording system 100 itself is static according to the acceleration information, and determines that the objects in the nearby environment of the video recording system 100 are static for a period of time according to the motion-sensing signal, the processing unit 110 determines that the usage status of the video recording system 100 is in idle status. In some embodiments, if the processing unit 110 determines that the usage status of the video recording system 100 is in the idle status according to the motion-sensing signal and the acceleration information mentioned above, the processing unit 110 controls the camera module 120 to stop recording images.

In some embodiments, the gravity sensor 144 is electrically connected to the processing unit 110 through the microcontroller 142, and senses the acceleration information of the video recording system 100 itself. In some embodiments, the function of the gravity sensor 144 is similar to the acceleration sensor 146, and will not be further described here.

In some embodiments, the microphone array 122 is electrically connected to the processing unit 110, and when the processing unit 110 activates the camera module 120, it activates the microphone array 122 to collect the sound of the scene as the sound source of the recorded video.

In some embodiments, the charging controller 154 is electrically connected to the processing unit 110, the battery 156 and the charging interface 152. In some embodiments, if the charging controller 154 detects that the external power source charges the battery 156 through the charging interface 152 and/or supplies power to the video recording system 100, the charging controller 154 transmits the charging information to the processing unit 110. In some embodiments, when the external power source supplies power to the video recording system 100, the processing unit 110 controls the network module 130 to transmit the recorded video to the cloud server CS. In some embodiments, when there is no external power source supplying power to the video recording system 100, the processing unit 110 enters the low power consumption mode to extend the usage time of the video recording system 100.

In some embodiments, the storage device 114 stores a plurality of neural networks, such as a neural network COM and at least one of the neural networks SPE1-SPE4. In some embodiments, each of the neural networks COM and SPE1-SPE4 includes an image segmentation neural network model and an object detection neural network model to perform the task of object detection. In some embodiments, the neural network SPE4 further includes an emotion recognition neural network model to perform the task of emotion recognition (for example, a concentration detection). In some embodiments, the basic architecture of the image segmentation neural network model may be implemented by a convolutional neural network architecture (for example, MobileNetV3), a deep neural network architecture, or other suitable neural network architecture, but is not limited thereto. In some embodiments, the basic architecture of the object detection neural network model may be implemented by a convolutional neural network architecture (for example, YoloV8), a deep neural network architecture, or other suitable neural networks, but is not limited thereto.

In some embodiments, the neural network COM is a pre-trained model, and its training set includes a generic object training set, so that the neural network COM may support the generic objects detection task. In some embodiments, the generic objects include objects such as cars, traffic lights, people, stores, products, buildings, facilities, animals, plants, tables, chairs. In some embodiments, the neural networks SPE1˜SPE4 are pre-trained models, and the training set used for training the neural networks SPE1-SPE4 includes a specific object training set, so that the neural network SPE1-SPE4 may support the detection task of specific objects.

In some embodiments, the neural network SPE1 supports detecting the specific objects related to the road scene. The specific objects related to the road scene include traffic lights state (for example, a red light, a yellow light, a green light, a left turn arrow light, and a right turn arrow light), car turn signal state, double yellow lines, zebra crossings, or other specific objects related to the road scene.

In other embodiments, the neural network SPE1 may also determine whether a specific event related to the road scene has occurred, such as making a left turn on a red light, and not yielding to pedestrians.

In some embodiments, the neural network SPE2 supports detecting specific objects related to the shopping scene. The specific objects related to the shopping scene include the stores trademarks, the products categories, or other specific objects related to the shopping scene.

In some embodiments, the neural network SPE3 supports detecting specific objects related to the travel scene. The specific objects related to the travel scene include famous landmarks (for example, rocks with specific shapes or contours, landscapes, buildings), amusement facilities, natural environments, special animals, swimming pools, tents, temples, forests, or other specific objects related to the travel scene.

In other embodiments, the neural network SPE3 may also determine whether the specific events related to the travel scene occur, such as fireworks, parades with float.

In some embodiments, the neural network SPE4 supports detecting the specific objects related to the conference scene. The specific objects related to the conference scene include the face bounding box of the participants and the information related to the face bounding box or other specific objects related to the conference scene.

The architecture of the neural network disclosed above is only used for illustrative purpose of the present disclosure and is not intended to limit the prevent disclosure.

In some embodiments, the memory device 112 stores at least one instruction code. In some embodiments, the processing unit 110 is electrically connected to the memory device 112. In some embodiments, when the processing unit 110 reads the at least one instruction code from the memory device 112, the processing unit 110 executes the image access method 200 of the video recording system 100.

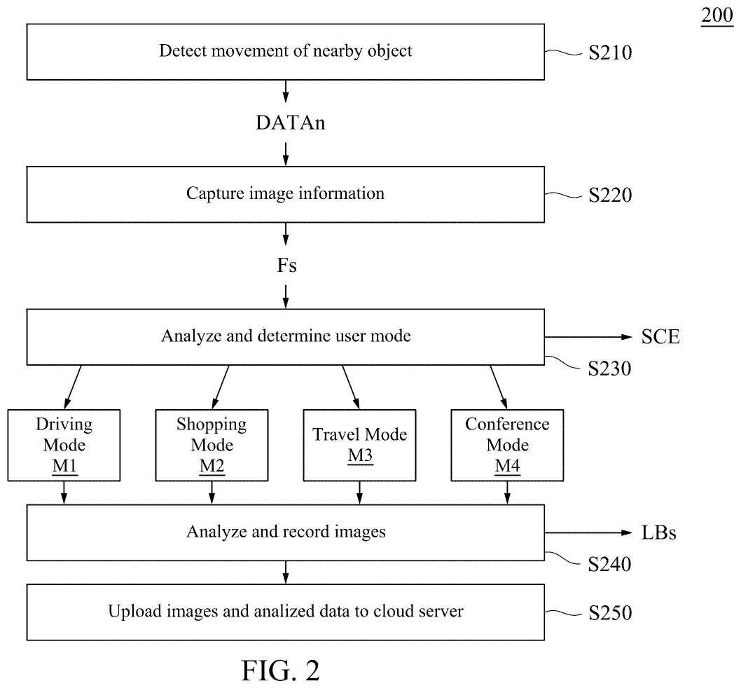

Please refer to FIG. 2. FIG. 2 is a schematic flowchart of an image access method 200 of the video recording system 100 in accordance with some embodiments of the present disclosure. In some embodiments, the image access method 200 includes Step S210, S220, S230, S240, and S250.

In Step S210, an activate event is triggered by the detection. In some embodiments, when the processing unit 110 controls the motion sensor 148 through the microcontroller 142 to detect the movement of people or objects in the nearby environment of the video recording system 100 and generates motion sensing data DATAn, the activation event is triggered. In other embodiments, when the object where the video recording system 100 is located moves, for example, a car or a human body starts to move, the activate event is triggered. When the activation event is triggered, the processing unit 110 may execute Step S220, which is to activate the camera module 120 to capture the image information.

During image information capturing in Step S220, the processing unit 110 may capture a plurality of images through the camera module 120 to generate a video, which contains a plurality of frames Fs.

In Step S230, the user mode is analyzed and determined. In some embodiments, the processing unit 110 performs the generic object detection on the plurality of frames Fs by the neural network COM to identify at least one generic object (for example, cars, people, buildings, stores) in the plurality of frames Fs. In some embodiments, the processing unit 110 determines an image scene SCE according to the at least one generic object. In some embodiments, the processing unit 110 determines the image scene SCE according to the category of the generic object and the area proportion of the bounding box.

For example, if there are a large number of car labels in the plurality of frames Fs, and the number of car labels exceeds a certain threshold, the processing unit 110 determines that the image scene SCE is the road scene. As another example, if there are a large number of store, shopping bag, or product labels in the plurality of frames Fs, and the number of store, shopping bag, or product labels exceeds the certain threshold, the processing unit 110 determines that the image scene SCE is the shopping scene. As another example, if there are a large number of facility, building, animal or plant labels in the plurality of frames Fs, and the number of facility, building, animal or plant labels exceeds the certain threshold, the processing unit 110 determines that the image scene SCE is the travel scene. As another example, if there are a large number of person, table, and chair labels in the plurality of frames Fs, and the number of person, table, and chair labels exceeds a certain threshold, the processing unit 110 determines that the image scene SCE is the conference scene.

In some embodiments, when the processing unit 110 locks/selects the user mode (that is, one of the neural networks SPE1-SPE4 to be loaded) according to the image scene SCE. In some embodiments, if the image scene SCE is the road scene, the processing unit 110 locks the user mode in the driving mode M1, loads the neural network SPE1, and then performs the specific object or specific event detection on the plurality of frames Fs according to the neural network SPE1. Please refer to the description above.

In some embodiments, if the image scene SCE is the shopping scene, the processing unit 110 locks the user mode in the shopping mode M2, loads the neural network SPE2, and then performs the specific object or event detection on the plurality of frames Fs according to the neural network SPE2. Please refer to the description above.

In some embodiments, if the image scene SCE is the travel scene, the processing unit 110 locks the user mode in the travel mode M3, loads the neural network SPE3, and then performs the specific object or specific event detection on the plurality of frames Fs according to the neural network SPE3. Please refer to the description above.

In some embodiments, if the image scene SCE is the conference scene, the processing unit 110 locks the user mode in the conference mode M4, loads the neural network SPE4, and then performs the specific object or event detection on the plurality of frames Fs according to the neural network SPE4. Please refer to the description above.

In Step S240, the images are analyzed and recorded. In some embodiments, when the processing unit 110 detects that at least one specific object appears in the plurality of frames Fs, the processing unit 110 attaches at least one label to the frame where the at least one specific object and/or specific event appears, and stores the frames with the at least one label. In some embodiments, when the number of frames where the at least one specific object appears is 1, the processing unit 110 stores the frame as an image file. In some embodiments, when the number of frames where the at least one specific object appears is greater than 1, the processing unit 110 edits the video into a dynamic image file or a short video to include the frame with the at least one specific object.

In Step S250, the images and analyzed data are uploaded to the cloud server CS. In some embodiments, the processing unit 110 controls the network module 130 to connect to the cloud server CS to upload the image files, dynamic image files, or short video files to the cloud server CS. The frames of the image files, dynamic image files or the short video files include the frame with the at least one specific object and/or at least one specific event. In some embodiments, the video recording system 100 further includes a user interface (not shown), which may be implemented by a display. In some embodiments, all stored labels may be displayed to the user by the user interface.

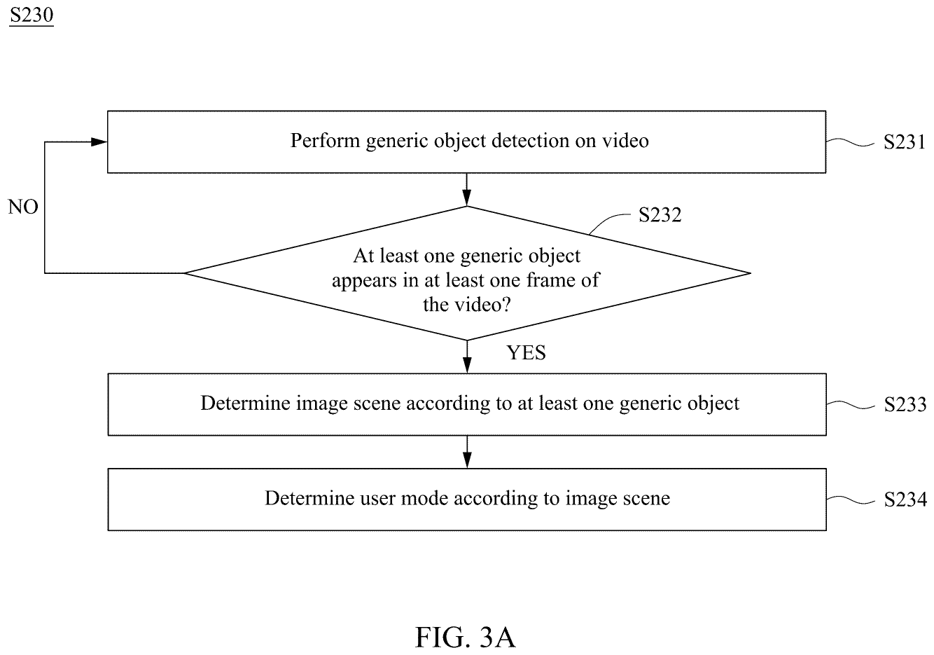

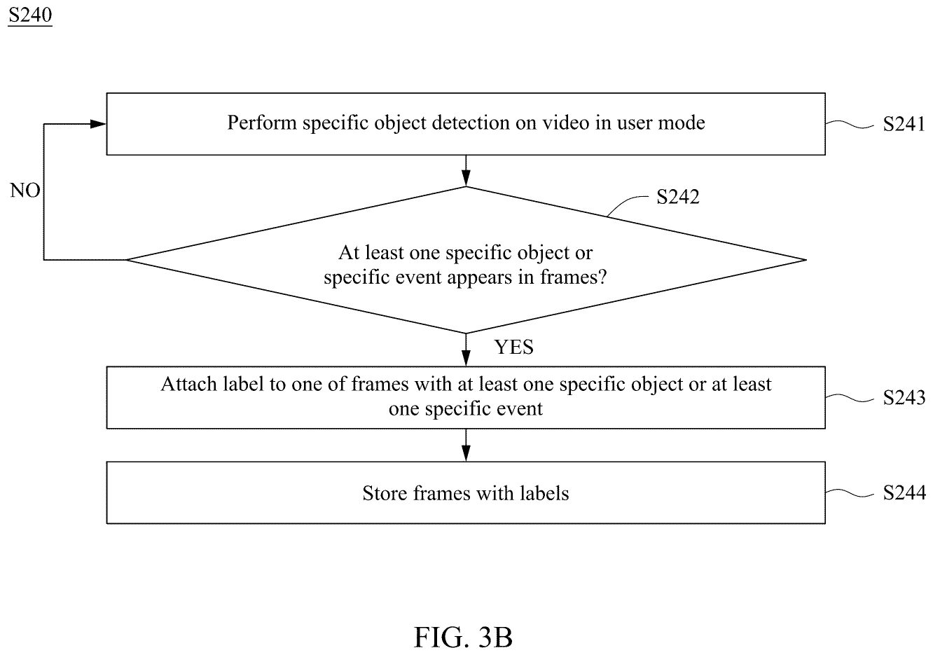

Please refer to FIGS. 3A and 3B. FIGS. 3A and 3B are schematic flowcharts of some steps of the image access method 200 in accordance with some embodiments of the present disclosure. In some embodiments, Step S230 includes Steps S231-S234. In some embodiments, Step S230 includes Steps S241-S244. In some embodiments, Steps S221, S231-S234, and Steps S241-S244 may be executed by the processing unit 110 accessing instructions and data stored in the memory device 112.

In Step S231, the generic object detection is used to the video.

In Step S232, it is determined whether the at least one generic object appears in the at least one frame of the video. In some embodiments, the processing unit 110 performs the generic object detection on the plurality of frames of the video to determine whether the at least one generic object appears in the frames. If it does not, Step S231 is executed.

If it does, Step S233 is executed, which is to determine the image scene based on the at least one generic object.

In Step S234, the user mode is determined based on the image scene.

In Step S241, in FIG. 2, one of the user modes, the specific object detection is performed on the video.

In Step S242, it is determined whether the at least one specific object or a specific event appears in the frames. If it does not, Step S241 is executed.

If it does, Step S243 is executed, which is to attach the label to one of the frames with the at least one specific object or at least one specific event. In Step S244, the labeled frames are stored.

In some embodiments, the image access method 200 further includes the following step. The frames with the at least one label are stored on the cloud server CS.

In some embodiments, the image access method 200 further includes the following step. According to the category of the at least one generic object and the area ratio of the bounding box, the image scene is determined. The image scene is one of the road scene, the shopping scene, the travel scene, and the conference scene.

In some embodiments, the image access method 200 further includes the following step. When the number of frames where the at least one specific object appearsequals 1, the frame is stored as the image file. When the number of frames where the at least one specific object appears is greater than 1, the video is edited into the dynamic image file or the short video file to include the frame with the at least one specific object.

In some embodiments, the image access method 200 further includes the following steps. All stored labels are displayed to the user through the user interface (for example, a display). When the user clicks on the at least one label, one of the image file, dynamic image file and short video file corresponding to the at least one label is displayed. In some embodiments, the image files, the dynamic image files and the short video files include the frames with the at least one specific object and/or the at least one specific event.

In some embodiments, the at least one specific object is one of a traffic sign, a natural landmark, an artificial landmark, a product trademark, a product item, a store name, and a vehicle.

In some embodiments, the at least one event includes one of an own traffic behavior, a surrounding traffic behavior, and a motion behavior.

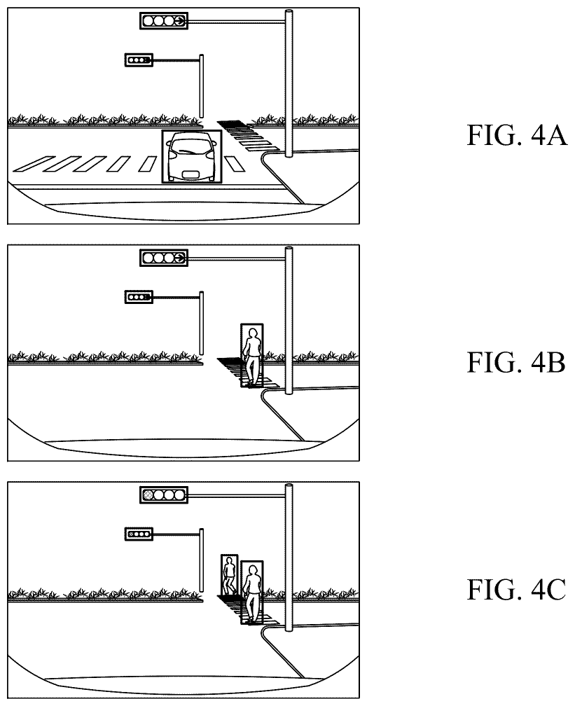

Please refer to FIGS. 4A to 4C. FIGS. 4A to 4C are schematic diagrams of the road scene in accordance with some embodiments of the present disclosure. As shown in FIGS. 4A to 4C, if the video recording system 100 is used as a driving recorder, the processing unit 110 receives the images captured by the camera module 120, detects the image including the generic objects such as traffic lights, cars, pedestrians by the neural network COM, and then locks the mode in the driving mode M1 according to the objects. In the driving mode M1, the processing unit 110 loads the neural network SPE1 to detect traffic lights state (for example, the light signal in FIGS. 4A and 4B are right-turn green lights, and the light signal in FIG. 4C is a red light), cars, pedestrians and other traffic objects, and the labels are attached to the frames according to the objects. In this way, the processing unit 110 according to the red light labels and the acceleration information corresponding to the frame of FIG. 4C (for example, the video recording system 100 detects that the car is in an acceleration status), may determine that the driving behavior has a suspected violation. The suspected violation includes non-violation but misjudged as a violation due to the current circumstances. In this case, the processing unit 110 edits the video clips according to the frame of FIG. 4C and a preset time length (for example, 300 seconds before and after the frame of FIG. 4C in the video), thereby retaining the image that the car has crossed the stop line under the right turn green light.

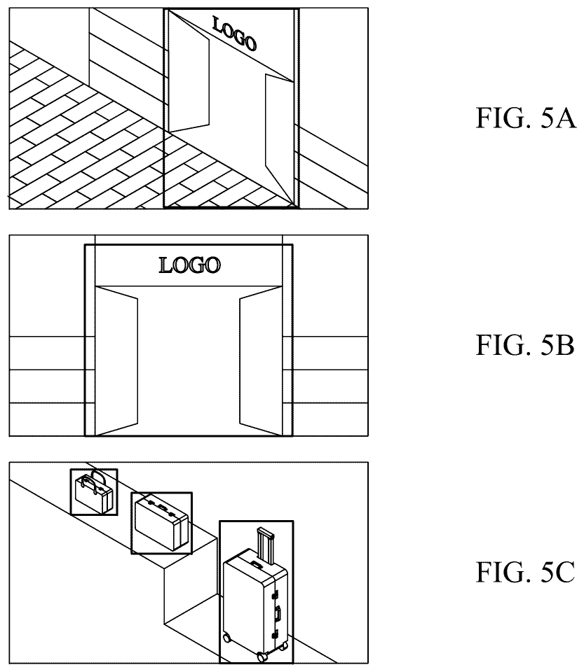

Please refer to FIGS. 5A to 5C. FIGS. 5A to 5C are schematic diagrams of the shopping scene in accordance with some embodiments of the present disclosure. As shown in FIGS. 5A to 5C, if the video recording system 100 is used as a handheld video recorder, the processing unit 110 receives the images captured by the camera module 120, detects the images including the generic objects such as stores and products by the neural network COM, and then locks the mode in the shopping mode M2 according to the objects. In the shopping mode M2, the processing unit 110 loads the neural network SPE2 to detect the product objects such as brands, handbags, suitcases in the image, and organizes the labeled items of the product objects such as brands, handbags, suitcases for a product list. In some embodiments, the processing unit 110 may further analyze the brand symbol on the product, and then mark the brand source on the bounding box of the corresponding product.

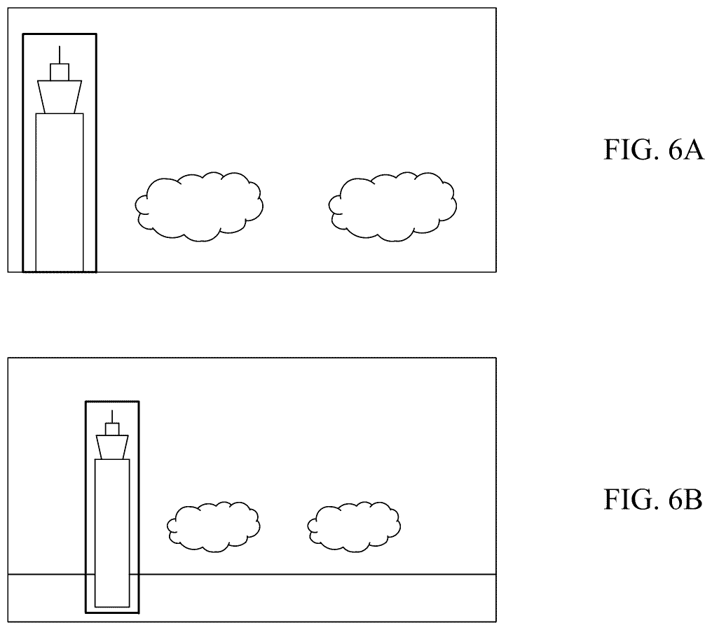

Please refer to FIGS. 6A to 6B. FIGS. 6A and 6B are schematic diagrams of the landscape scene in accordance with some embodiments of the present disclosure. As shown in FIGS. 6A and 6B, if the video recording system 100 is used as a handheld video recorder, the processing unit 110 receives the images captured by the camera module 120, detects the images including the generic objects such as buildings by the neural network COM, and then locks the mode in the travel mode M3 according to the objects. In the travel mode M3, the processing unit 110 loads the neural network SPE3 to detect whether the building in the image is a famous landmark and attaches a corresponding label to the frame of the video based on the detection result.

In summary, the video recording system 100 of this disclosure may automatically analyze the specific objects in the video and attach labels to each image frame of the video. In this way, users may filter the image clips that match the specific image scenes (for example, a road scene, a shopping scene, a travel scene, and a conference scene) according to the labels. Furthermore, users may filter the image clips that match the specific objects (for example, a product category, brand information, natural environment category, animal category, facility category, or a famous landmark) according to the labels. In this way, the video content of the recorded video may be classified and to query easier, thereby increasing the value of the recorded video.

It will be apparent to those skilled in the art that various modifications and variations can be made to the structure of the disclosure without departing from the scope or spirit of the disclosure cover modifications and variations of this disclosure provided they fall within the scope of the following claims.

What is claimed is:

1. A video recording system, comprising:
a camera;
a memory device for storing at least one script code;
a processor electrically connected to the camera and the memory device for performing operations when executing the at least one script code, the operations comprising:
capturing a plurality of images through the camera to generate a video;
identifying at least one generic object in a plurality of frames in the video;
determining an image scene according to the at least one generic object;
performing a specific object detection according to the image scene to determine whether at least one specific object or at least one specific event appears in the frames; and
attaching a label to at least one of the frames with the at least one specific object or the at least one specific event.

2. The video recording system of claim 1, further comprising:
a storage device electrically connected to the processor and configured to store a first neural network and a plurality of second neural networks, wherein the processor is further for performing the operations comprising:
performing a generic object detection on the frames of the video to identify the at least one generic object in the frames by the first neural network;
determining the image scene according to the at least one generic object;
selecting one of the second neural networks according to the image scene; and
performing the specific object detection on the frames to identify the at least one specific object or the at least one specific event in the frames by the one of the second neural networks.

3. The video recording system of claim 1, further comprising:
a motion sensor electrically connected to the processor and configured to sense a surrounding environment to generate a motion-sensing signal;
wherein when the processor receives the motion-sensing signal, the processor controls the camera to start to generate the video.

4. The video recording system of claim 3, further comprising:
an acceleration sensor electrically connected to the processor and configured to sense an acceleration information of the camera,
wherein the processor controls the camera to stop recording according to the acceleration information and the motion-sensing signal.

5. The video recording system of claim 4, further comprising:
a network electrically connected to the processor and configured to transmit data to a cloud server,
wherein the processor transmits the at least one frame with the label to the cloud server according to the acceleration information and the motion-sensing signal.

6. An image access method, comprising:
performing a generic object detection on a plurality of frames of a video to identify at least one generic object in the frames;
determining an image scene according to the at least one generic object;
performing a specific object detection on the frames according to the image scene to determine whether at least one specific object or at least one specific event appears in the frames;
when the at least one specific object or the at least one specific event is detected in the frames, attaching at least one label to the frame where the at least one specific object or the at least one specific event appears; and
storing the frames with the at least one label.

7. The image access method of claim 6, further comprising:
storing the frames with the at least one label on a cloud server.

8. The image access method of claim 6, further comprising:
determining the image scene according to a category of the at least one generic object and an area ratio of a bounding box;
wherein the image scene is one of a road scene, a shopping scene, a travel scene, and a conference scene.

9. The image access method of claim 6, further comprising:
when a number of the frames where the at least one specific object appears is 1, storing the frame as an image file; and
when a number of the frames where the at least one specific object appears is greater than 1, editing the video into a dynamic image file or a short video file to contain the frames with the at least one specific object.

10. The image access method of claim 6, further comprising:
displaying all stored labels to a user through a user interface;
when the user clicks the at least one label, displaying one of an image file, a dynamic image file, and a short video file corresponding to the at least one label;
wherein the image file, the dynamic image file and the short video file contain the frames with the at least one specific object or the at least one specific event.

11. The image access method of claim 6, wherein the at least one specific object is one of a traffic sign, a natural landmark, an artificial landmark, a product trademark, a product item, a store name, and a vehicle.

12. The image access method of claim 6, wherein the at least one specific event comprises one of an own traffic behavior, a surrounding traffic behavior, and a movement behavior.

13. A non-transitory computer-readable medium storing at least one script code, when the at least one script code is executed by a processor, the processor performs operations comprising:
performing a generic object detection on a plurality of frames of a video to identify at least one generic object in the frames;
determining an image scene according to the at least one generic object;
performing a specific object detection on the frames according to the image scene to determine whether at least one specific object or at least one specific event appears in the frames;
when the at least one specific object or the at least one specific event is detected in the frames, attaching at least one label to the frames where the at least one specific object or the at least one specific event appears; and
storing the frames with the at least one label.

14. The non-transitory computer readable medium of claim 13, wherein when the at least one script code is executed by the processor, the processor performs the operations further comprising:
connecting to a cloud server; and
storing the frames with the at least one label on the cloud server.

15. The non-transitory computer readable medium of claim 13, wherein when the at least one script code is executed by the processor, the processor performs the operations further comprising:
when a number of the frames where the at least one specific object appears is 1, storing the frame as an image file; and
when a number of the frames where the at least one specific object appears is greater than 1, editing the video into a dynamic image file or a short video file to contain the frames with the at least one specific object.
